(19) United States
(12) Patent Application Publication
(10) Pub. No.: US 2008/0083281 A1
(43) Pub. Date: Apr. 10, 2008

(54) PROCESS FOR MEASUREMENT OF THE LEVEL OF A MEDIUM IN A CONTAINER BASED ON THE RADAR PRINCIPLE

(75) Inventors: Ilona ROLFES, Bochum (DE); Thomas MUSCH, Muelheim an der Ruhr (DE)

Correspondence Address: ROBERTS, MLOTKOWSKI & HOBBES, P. O. BOX 10064, MCLEAN, VA, 22102-8064, US

(73) Assignee: KROHNE S.A., Romans-Cedex (FR)

(21) Appl. No.: 11/539,977

(22) Filed: Oct. 10, 2006

(51) Int. Cl. G01N 37/00

(52) U.S. Cl. 73/627

(57) ABSTRACT

A process for measurement of the level of a medium in a container based on the radar principle in which a measurement signal is generated and emitted in the direction of the medium, the portion of the measurement signal which has been reflected back is detected and the level determined from the propagation time of the measurement signal. The portion of the measurement signal which has been reflected back is evaluated in a phase-sensitive manner in order to assign the respective level corresponding to the propagation time of the measurement signal to a specific direction of space. Thus, the level is determined even under difficult conditions, such as when structures or devices are present in the container or when loose bulk materials are present in loose bulk cones.

### BACKGROUND OF THE INVENTION

1. Field of the Invention

The invention relates to a process for measurement of the level of a medium in a container based on the radar principle, a measurement signal being generated and emitted in the direction of the medium, the portion of the measurement signal which has been reflected back being detected and the level being determined by means of the propagation time of the measurement signal.

2. Description of Related Art

Level measurement processes of the initially named type are known from the prior art, such as International Patent Application Publication WO 01/11323 A1 and corresponding U.S. Pat. No. 6,310,574. In industrial applications, the task is often to determine the level of a medium, such as a liquid or loose bulk material in a container, such as a tank. A host of techniques is known for this purpose, its being distinguished between contact level measurement processes, on the one hand, and the noncontact level measurement processes, on the other hand. In contact level measurement processes, a component of the measurement means, for example, a float, a buoyancy body, or a feeler plate, comes into contact with the medium the level of which is to be measured. Furthermore, contact level measurement processes include capacitive measurements in which the level is detected depending on the capacitance between an electrode which dips into the medium and the wall of the container, and a thermal measurement in which increased heat dissipation, when a temperature-dependent resistance through which current has flowed is immersed into the medium, is used in which the electrical resistance changes with immersion depth.

Noncontact level measurement processes include, for example, measurement by means of a laser or ultrasound. In this connection, a laser or an ultrasonic signal is emitted, reflected on the surface of the medium, and the reflected signal is detected again, the level of the medium being deduced via the propagation time of the signal. The radar level measurement process is based on the same principle; in it a microwave signal is produced, emitted via an antenna, such as a rod antenna, a horn antenna or a patch antenna, in the direction toward the medium the level of which is to be measured, is reflected on the surface of the medium and is detected again by the antenna or another antenna.

In this connection, there are various radar level measurement processes: in the pulsed radar level measurement process a microwave signal is emitted in short pulses, unmodulated or carrier frequency-modulated. The distance between the transmitter/receiver and the medium is determined from the propagation time of the microwave pulses from the transmitter to the surface of the medium and back to the receiver, and a common antenna can be used as the transmitter and receiver. In frequency modulated continuous wave (FMCW) radar level measurement processes, the microwave signal is continuously present, but the frequency is modulated, typically in successive ramps. The delay time during signal propagation changes the transmitting frequency when the reflected signal is received so that from the frequency difference, the distance of the reflecting surface, and thus, the level can be deduced. Finally, the Time Domain Reflectometry (TDR) radar level measurement process is known which is similar to the pulsed radar level measurement processes, but generally works in a line-linked manner and uses electrical pulses without a carrier frequency.

Sometimes the problem is, especially when determining the level of loose bulk materials, that the level cannot be directly deduced by means of the propagation time of the portion of the measurement signal which has been reflected back. For loose bulk materials, typically there is no planar surface, but rather a cone of bulk material, so that no defined, distinct level exists at all. Moreover, it can occur that the emitted measurement signal is not reflected by the medium provided in the tank, but by a mechanism mounted in the tank, such as a stirring mechanism.

In the initially addressed International Patent Application Publication WO 01/11323 A1 and corresponding U.S. Pat. No. 6,310,574, a system is described which works with very high frequencies of a few GHz, typically even more than 24 GHz. This yields an extremely narrow radiation characteristic of the emitting antenna used, so that the measurement signal can be emitted in a defined manner in a certain narrow direction of space. In this way, the emitted signal can be consciously prevented from hitting a mechanism provided in the container, such as a stirring mechanism. Moreover, the location at which the emitted measurement signal strikes the medium provided in the container can be accurately fixed. Nevertheless, determination of the level of loose bulk materials, especially due to the presence of a loose bulk cone, is difficult.

### SUMMARY OF THE INVENTION

Thus, a primary object of the present invention is to devise a process for measuring the level of a medium provided in a container with which a reliable level determination is enabled even under difficult boundary conditions, such as when structures or devices are in the container or when loose bulk materials are present in loose bulk cones.

Proceeding from the initially described process, the aforementioned object is achieved in that the portion of the measurement signal which has been reflected back is evaluated in a phase-sensitive manner, in order to assign the respective level corresponding to the propagation time of the measurement signal relative to a certain direction in space.

Therefore, it is provided in accordance with the invention that the distance of the medium which is decisive for reflection in different directions of space be deduced from the phase information in the portion of the measurement signal which has been reflected back. It is critical to the invention that, in addition to the amplitude of the portion of the measurement signal reflected back, the phase is also evaluated. In the optimum case, essentially the entire irradiated surface can be delivered to solid angle-dependent evaluation with respect to the distance between the transmitting/receiving antenna means and the reflecting medium. As a result, defined conclusions can be drawn about the structure of the medium in the container and about structures or devices in the container which may contribute to back reflection of the measurement signal.

Generally, any normal antenna used for radar level measurements has such an emission characteristic with which an extended solid angle is “illuminated,” especially also with respect to the fact that more or less strongly pronounced secondary lobes occur. However, in order to achieve optimum “illumination” of the region of interest, according to a preferred development of the invention, it is provided that the measurement signal is emitted in a host of directions of space. Accordingly, it is therefore provided that, not only is the “normal” divergence of the emitted signal used in order to achieve broad “illumination,” but that the measurement signal is intentionally emitted in a host of solid angles. Here, it is quite especially preferred that the measurement signal is emitted at the same time essentially in the entire angular region facing the medium; this means emission in the solid angle range of 2π in the extreme case for an extremely short distance between the transmitting/receiving antenna means, on the one hand, and the medium, on the other hand.

According to a preferred development of the invention, it is also provided that, to detect the portion of the measurement signal which has been reflected back, a host of receiving antennas is used. In this connection, preferably, also the portion of the measurement signal which has been reflected back and received by the respective receiving antenna is subjected to its own phase shift. Here, it is an especially good idea to use an array of patch antennas as the receiving antennas.

Fundamentally, the phase shift, and thus, the phase-sensitive evaluation of the signal received by the individual receiving antennas could be implemented using individual phase shifters assigned to the respective receiving antenna. Instead of such an analog phase shift, according to a preferred development of the invention, it is provided that a digital phase shift be used, specifically by phase-sensitive evaluation taking place within the framework of digital signal processing.

Furthermore, according to a preferred development of the invention, it is provided that the topography of the medium in the container is determined by means of the level values determined for different directions of space. According to a preferred development of the invention, it can also be provided that, by means of the topography of the medium, its volume is determined. This is especially interesting for loose bulk materials which do not have a defined level when a loose bulk cone is present, so that a detectable value for the amount of medium in the container is nevertheless obtained via the volume determined by means of the topography.

In particular, a host of embodiments and developments of the invention are conceivable. In this respect, reference is made to the following detailed description of a preferred embodiment of the invention with reference to the accompanying drawings.

### BRIEF DESCRIPTION OF THE DRAWINGS

FIG. 1 schematically shows a level measurement device for executing the level measurement process according to a preferred embodiment of the invention,

FIG. 2 shows a receiving antenna used for executing the level measurement process according to a preferred embodiment of the invention, and

FIG. 3 schematically shows the phase-sensitive evaluation of the portion of the measurement signal which has been reflected back.

### DETAILED DESCRIPTION OF THE INVENTION

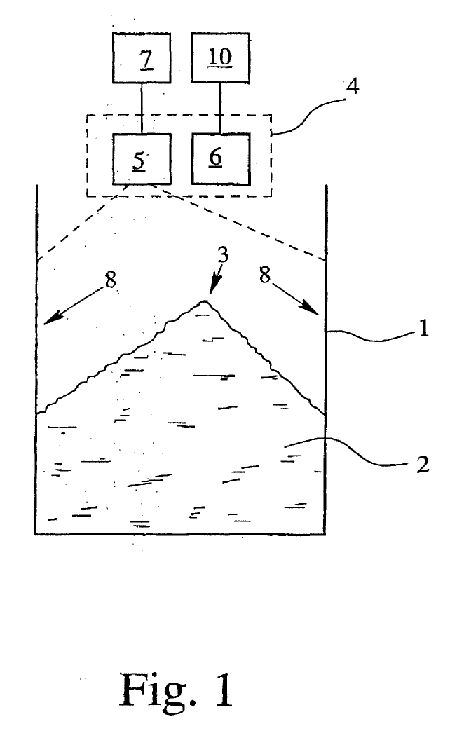

The level measurement device shown in FIG. 1 for executing a level measurement process according to a preferred embodiment of the invention is used for a container 1, in which there is a medium 2, here, specifically a loose bulk material with a loose bulk cone 3. The level measurement device has a transmitting and receiving antenna means 4 with a transmitting antenna means 5 and a receiving antenna means 6. A microwave signal produced in a microwave generation means 7 is supplied to the transmitting antenna 5 and emitted by it, as indicated in FIG. 1 with the broken lines, at the same time in essentially the entire solid angle facing the medium 2. As is recognized, this can take place in a host of ways, among others, specifically by using a transmitting antenna means 5 comprised of a host of individual antennae and a downstream dielectric lens.

The measurement signal emitted by the transmitting antenna means 5 is then reflected in the container 1, specifically on the surface of the medium 2 and partially also on the inside walls 8 of the container 1. These measurement signal portions which have been reflected back among others strike the receiving antenna 6 as is made below:

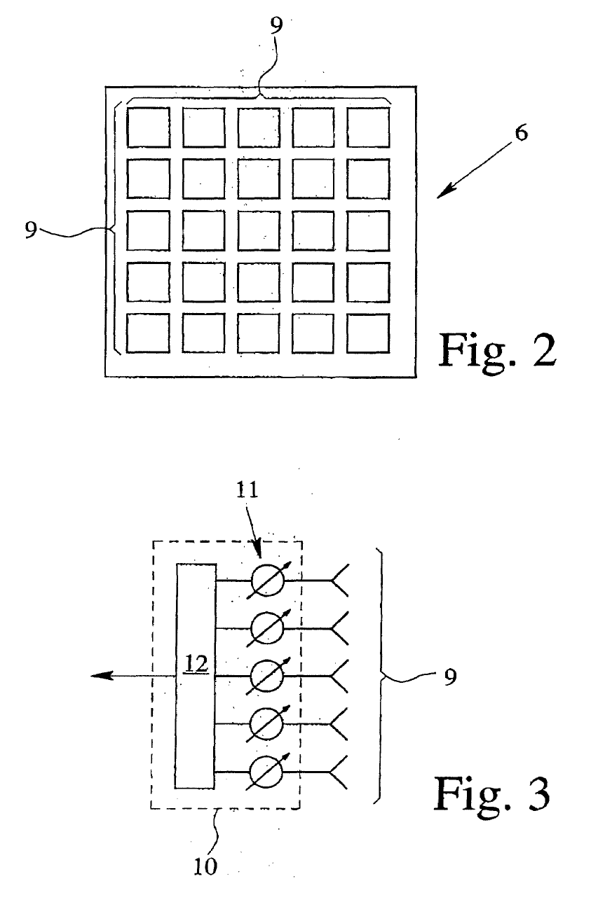

As shown schematically in FIG. 2, the receiving antenna means 6 is a patch antenna which is comprised of a host, here 5×5 individual antenna elements 9. As is furthermore apparent from FIGS. 1 & 3, the receiving antenna means 6, and thus, the individual antenna elements 9 are connected upstream of the signal processing means 10. In this signal processing means 10, phase-sensitive evaluation of the portions of the reflected-back measurement signal which have been received by the individual antenna elements takes place. This is shown schematically in FIG. 3 by phase shifters 11 which, however, are not implemented here as microwave phase shifters, but within the framework of signal processing using software. Thus, for each respective individual antenna element 9, a phase-sensitive signal is produced which within the framework of signal processing 12 ultimately enables determination of the topology of the medium 2 located in the container 1 via the distance corresponding to the respective solid angle between the transmitting antenna 5, the reflecting point of the medium 2 and the receiving antenna.

At known dimensions of the container 1, the volume of the medium 2 can thus be determined and output, as shown in FIG. 3. Thus, especially for loose bulk materials with a loose bulk cone, in spite of the absence of a defined level, a reliable quantity for the amount of the medium 2 in the container 1 can be obtained.

What is claimed is:

1. Process for measurement of the level of a medium in a container based on the radar principle, comprising the steps of:
generating a measurement signal and emitting it toward the medium in the container,
detecting a portion of the measurement signal which has been reflected back, and
determining the level of the medium by the propagation time of the measurement signal,
wherein at least one portion of the measurement signal which has been reflected back is evaluated in a phase-sensitive manner and the respective level assigned corresponding to the propagation time of the measurement signal relative to a specific direction of space.

2. Process in accordance with claim 1, wherein the measurement signal is emitted in a host of directions.

3. Process in accordance with claim 2, wherein the measurement signal is emitted at the same time essentially into the entire angular region facing the medium.

4. Process in accordance with claim 3, wherein a plurality of individual antenna elements is used to detect a number of reflected-back portions of the measurement signal.

5. Process in accordance with claim 2, wherein a plurality of individual antenna elements is used to detect a number of reflected-back portions of the measurement signal.

6. Process in accordance with claim 5, wherein the reflected-back portion of the measurement signal received by the respective individual antenna element is subjected to a respective phase shift.

7. Process in accordance with claim 5, wherein the receiving antenna is an array of patch antennas.

8. Process in accordance with claim 1, comprising the further step of determining the topography of the medium in the container by means of the level values determined for the different directions of space.

9. Process in accordance with claim 8, wherein the volume of the medium is computed by means of its topography.

10. Process in accordance with claim 5, comprising the further step of determining the topography of the medium in the container by means of the level values determined for the different directions of space.

11. Process in accordance with claim 10, wherein the volume of the medium is computed by means of its topography.
